(19) United States
(12) Patent Application Publication
(10) Pub. No.: US 2017/0163154 A1
(43) Pub. Date: Jun. 8, 2017

(54) VOLTAGE BOOST CIRCUIT

(71) Applicant: Wistron Corporation, New Taipei City (TW)

(72) Inventor: Mingzhou Yee, New Taipei City (TW)

(21) Appl. No.: 15/132,248

(22) Filed: Apr. 19, 2016

(30) Foreign Application Priority Data
Dec. 4, 2015 (CN) 201510891900.4

(51) Int. Cl. H02M 3/158

(52) U.S. Cl. CPC H02M 3/158

(57) ABSTRACT

A voltage boost circuit includes an energy storage component coupled to an input voltage source; a plurality of switch units, wherein when each of the switch units is conducted, the input source, the energy storage component and the each switch unit form a conducting path, such that the input voltage source charges the energy storage component; and a control unit for sequentially conducting the plurality of switch units according to a driving signal.

### BACKGROUND OF THE INVENTION

1. Field of the Invention

The present invention relates to a voltage boost circuit, and more particularly, to a voltage boost circuit capable of improving efficiency.

2. Description of the Prior Art

In an electronic device, a direct current to direct current (DC to DC) voltage conversion circuit can be used to adjust voltage levels. For example, a voltage boost circuit can generate an output voltage that is higher than an input voltage. With advanced development in circuit technology, the voltage boost circuit has developed to meet various system requirements or architectures.

For example, please refer to FIG. 1, which is schematic diagram illustrating a voltage boost circuit 10 according to the prior art. The voltage boost circuit 10 includes an input end 100, an inductor 110, a transistor 112, a diode 120, an output end 130 and an output unit 140. The output unit 140 includes an output capacitor 142 and output resistors 144, 146. The on state and cut-off state of the transistor 112 are controlled by the driving signal SC. During a charging process of the voltage boost circuit 10, the transistor 112 is turned on, such that the input voltage source Vin, the inductor 110 and the transistor 112 form a conducting path, and the input voltage source Vin charges the inductor 110, such that the inductor 110 stores energy. During a discharging process of the voltage boost circuit 10, the transistor 112 is turned off. Thus, the inductor 110 and the output capacitor 142 of the output unit 140 form a discharge path, such that the inductor 110 transfers the stored energy to the output capacitor 142 for generating the output voltage Vout. The output voltage Vout is higher than the input voltage source Vin, so as to achieve the voltage boost purpose.

In short, the voltage boost circuit 10 accumulates the energy in the charging process and outputs the output voltage Vout which is higher than the input voltage source Vin in the discharging process according to the on/off state of the transistor 112. However, during the step up operation period of the voltage boost circuit 10, the transistor 112 often overheats and is destroyed since a large current flowing through the transistor 112, thus resulting in a circuit failure of the voltage boost circuit 10.

Moreover, please refer to FIG. 2, which is schematic diagram illustrating a voltage boost circuit 20 according to the prior art. As shown in FIG. 2, the voltage boost circuit 20 includes an input end 200, an inductor 210, a diode 220, an output end 230, an output unit 240 and transistors 212, 214. The output unit 240 includes an output capacitor 242, output resistors 244, 246. The on state and cut-off state of the transistors 212, 214 are controlled by the driving signal SC. Different from the voltage boost circuit 10, the transistor 212 and the transistor 214 of the voltage boost circuit 20 are connected in parallel for shunting the input current, such that the transistor 212 or the transistor 214 may not overheat or be destroyed. However, because the transistors 212, 214 are connected in parallel and operate simultaneously, the switching frequency of the transistors 212, 214 of the voltage boost circuit 20 is twice of the switching frequency of the transistor 112 of the voltage boost circuit 10, thus reducing the efficiency of the voltage boost circuit. Thus, the prior art has to be improved.

### SUMMARY OF THE INVENTION

Therefore, an objective of the present invention is to provide a voltage boost circuit capable of reducing the switching frequency and protecting circuit.

The present invention discloses a voltage boost circuit including an energy storage component coupled to an input voltage source; a plurality of switch units, wherein when each of the switch units is conducted, the input voltage source, the energy storage component and the each switch unit form a conducting path, such that the input voltage source charges the energy storage component; and a control unit for sequentially conducting the plurality of switch units according to a driving signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams respectively illustrating a voltage boost circuit according to the prior art.

FIG. 3 is a schematic diagram illustrating a voltage boost circuit according to an embodiment of the present invention.

FIG. 4 is a timing diagram illustrating the driving signal shown in FIG. 3.

FIG. 5A is a schematic diagram illustrating a voltage boost circuit according to an alternative embodiment of the present invention.

FIG. 5B to FIG. 5D are schematic diagrams illustrating the operations of the voltage boost circuit shown in FIG. 5A in different period respectively.

FIG. 6 is a schematic diagram illustrating a voltage boost circuit according to an alternative embodiment of the present invention.

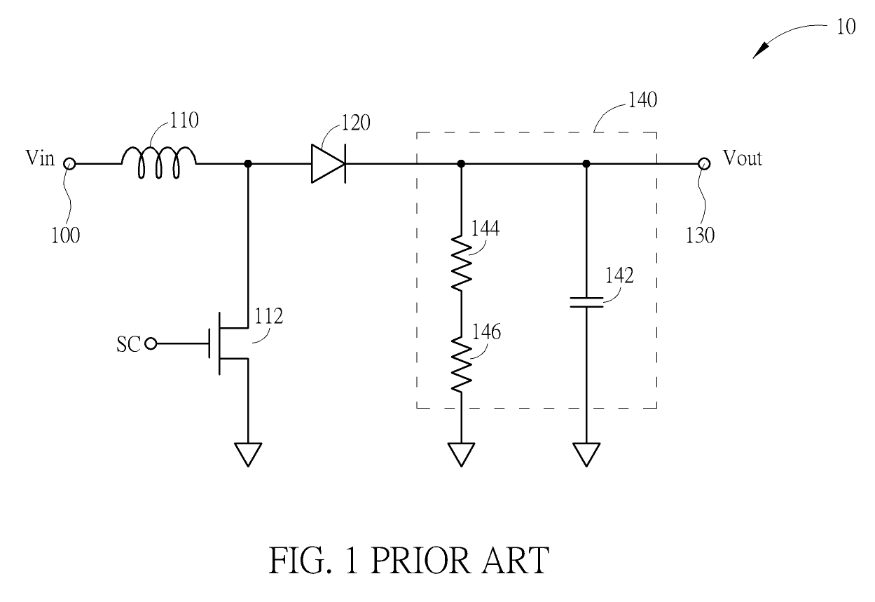

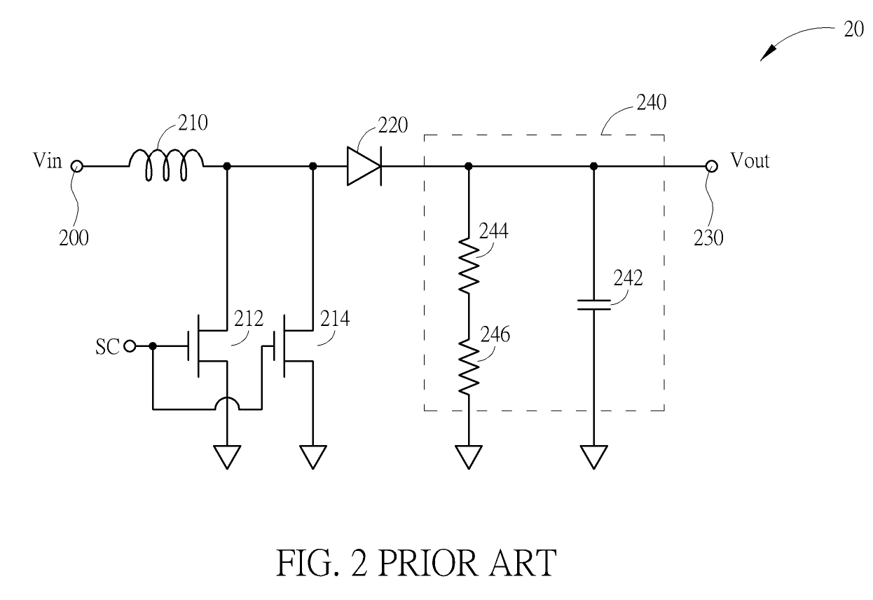

### DETAILED DESCRIPTION

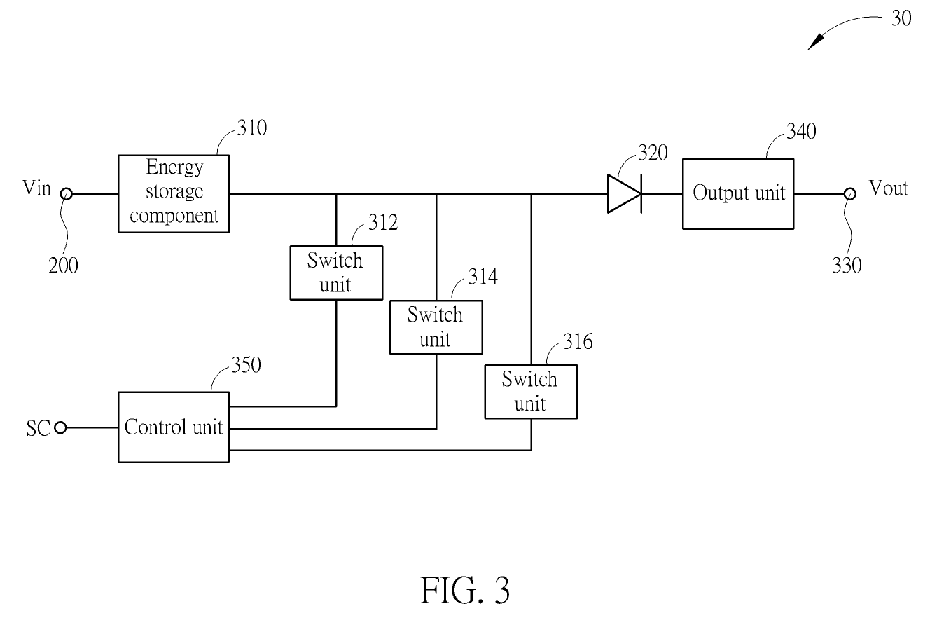

Please refer to FIG. 3, which is a schematic diagram illustrating a voltage boost circuit 30 according to an embodiment of the present invention. The voltage boost circuit 30 includes an input end 300, an energy storage component 310, a diode 320, an output end 330, an output unit 340, a control unit 350 and switch units 312, 314, 316. The input end 300 is coupled to an input voltage source Vin. The energy storage component 310 is utilized for controlling and transferring electrical energy. For example, the energy storage component 310 can store electrical energy provided from the input voltage source Vin when any switch unit is conducted (turned on) and output the stored electrical energy to the output unit 340 when the switch units are off (turned off). The control unit 350 is utilized for sequentially conducting the plurality of switch units according to a driving signal SC. When each of the switch units is conducted, the input voltage source Vin, the energy storage component 310 and the conducted switch units form a conducting path (charging path), such that the input voltage source Vin charges the energy storage component 310.

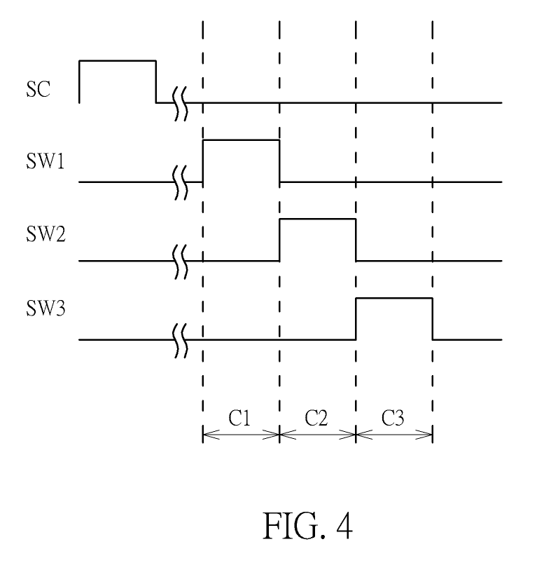

In detail, please refer to FIG. 4. FIG. 4 is a timing diagram illustrating an embodiment of the driving signal SC shown in FIG. 3. The driving signal SC maybe generated by a driving device (not shown in figures) and provided to the control unit 350. After the control unit 350 receives the driving signal SC, the control unit 350 outputs a first switch signal SW1 to the switch unit 312 according to the driving signal SC, such that the switch unit 312 is conducted in a first period C1. In such a condition, the input voltage source Vin, the energy storage component 310 and the switch unit 312 form a conducting path, and the input voltage source Vin charges the energy storage component 310 in the first period C1. In a second period C2, the control unit 350 outputs a second switch signal SW2 to the switch unit 314 according to the driving signal SC, such that the switch unit 314 is conducted. Therefore, the input voltage source Vin, the energy storage component 310 and the switch unit 314 form a conducting path, and the input voltage source Vin charges the energy storage component 310 in the second period C2. In a third period C3, the control unit 350 outputs a third switch signal SW3 to the switch unit 316 according to the driving signal SC, such that the switch unit 316 is conducted. Similarly, the input voltage source Vin, the energy storage component 310 and the switch unit 316 form a conducting path, such that the input voltage source Vin charges the energy storage component 310. The first period C1, the second period C2 and the third period C3 may be not overlapping. In brief, the control unit 350 sequentially conducts the switch unit 312, the switch unit 314 and the switch unit 316 in different periods according to the driving signal SC, so as to charge and store electrical energy in the energy storage component 310 when each of the switch units is conducted. When the switch units 312, 314, 316 are turned off, the energy storage component 310 can output the stored electrical energy to the output unit 340 so as to generate an output voltage Vout, and thus achieving the purpose of voltage conversion.

In an embodiment, the driving signal SC, the first switch signal SW1, the second switch signal SW2 and the third switch signal SW3 have the same signal waveform. In the first period C1, the control unit 350 may send the received driving signal SC to the switch unit 312 (i.e. the received driving signal SC is utilized as the first switch signal SW1 in the first period C1), such that the switch unit 312 is conducted in the first period C1. In the second period C2, the control unit 350 sends the received driving signal SC to the switch unit 314 (i.e. the received driving signal SC is utilized as the second switch signal SW2 in the second period C2), such that the switch unit 314 is conducted in the second period C2. In the third period C3, the control unit 350 sends the received driving signal SC to the switch unit 316 (i.e. the received driving signal SC is utilized as the third switch signal SW3 in the third period C3), such that the switch unit 316 is conducted in the third period C3.

In other words, under the control of the control unit 350, the switch units 312, 314, 316 are conducted in different time interval, and the energy storage component 310 is charged. By utilizing the control of the control unit 350, the driving device has only to generate the driving signal SC and the energy storage component 310 can be charged in the first period C1, the second period C2 and the third period C3 accordingly.

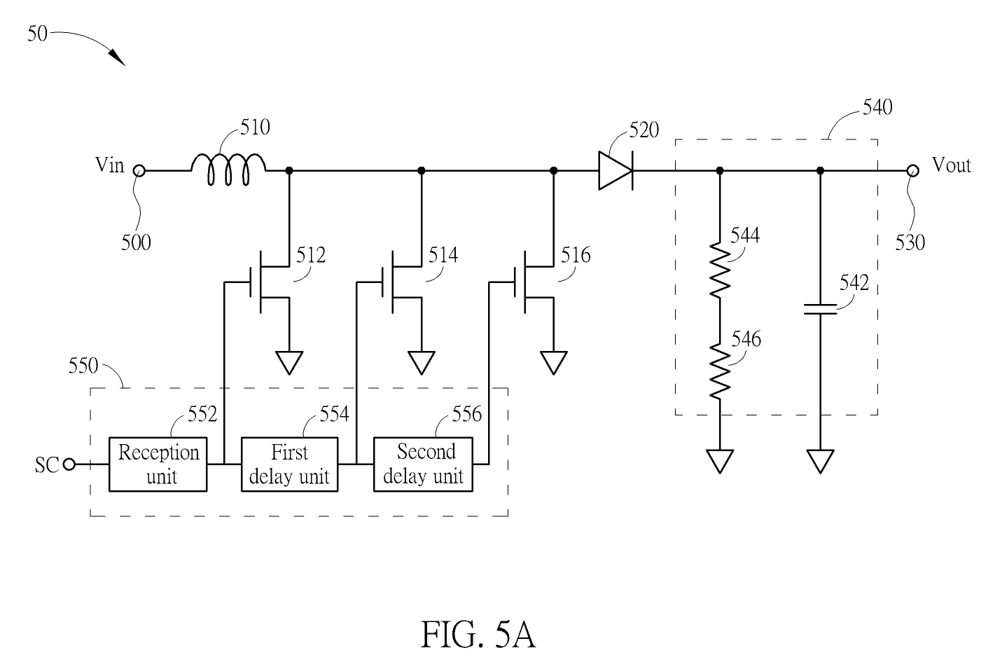

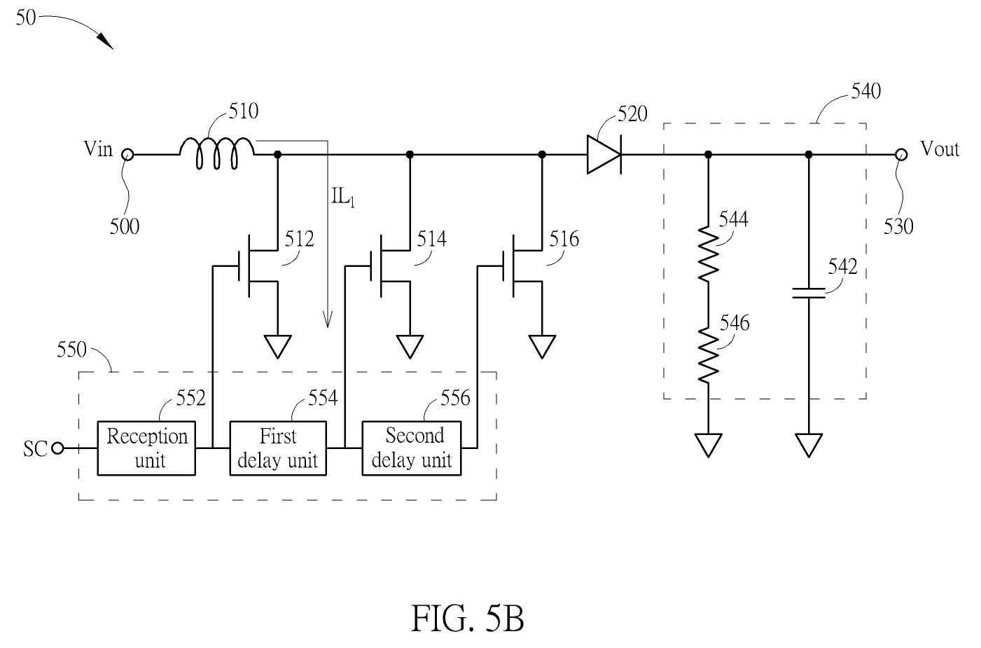

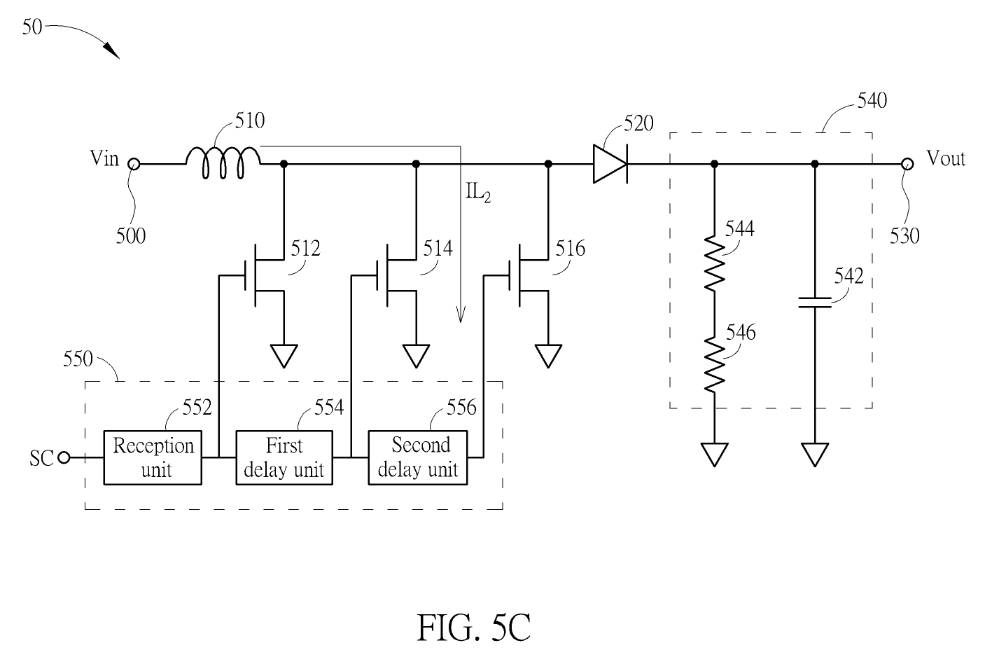

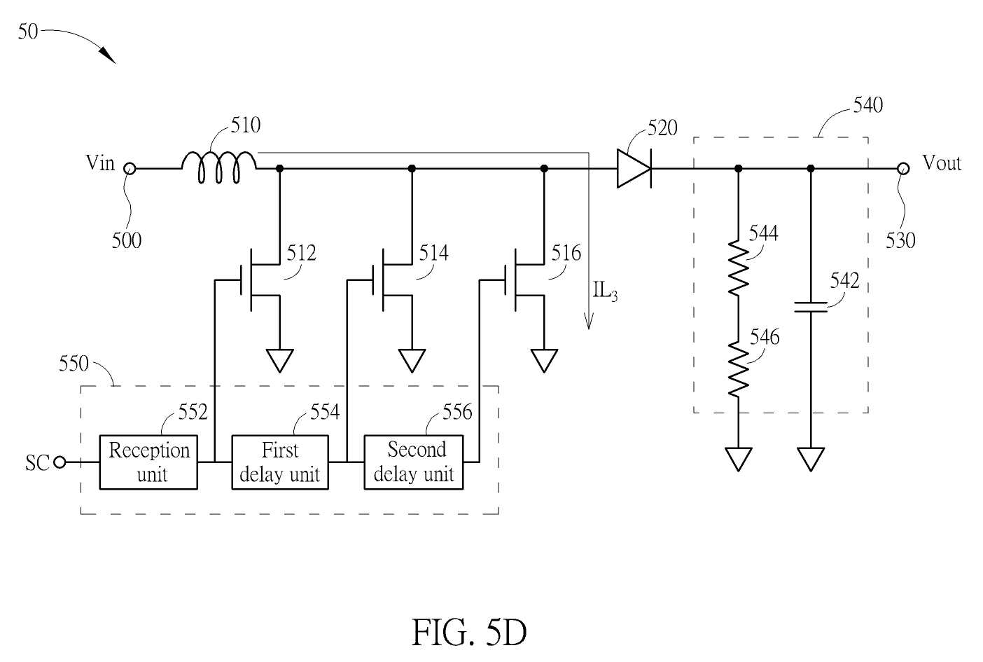

Please refer to FIG. 5A, which is a schematic diagram illustrating a voltage boost circuit 50 according to an embodiment of the present invention. The voltage boost circuit 50 includes an input end 500, an inductor 510, a diode 520, an output end 530, an output unit 540, a control unit 550 and transistors 512, 514, 516. The output unit 540 includes an output capacitor 542 and output resistors 544, 546. The control unit 550 includes a reception unit 552, a first delay unit 554 and a second delay unit 556. Please refer to FIG. 5A to FIG. 5D. FIG. 5B to FIG. 5D are schematic diagrams illustrating the operations of the voltage boost circuit 50 in the first period C1, the second period C2 and the third period C3 respectively. First, after the reception unit 552 receives a driving signal SC, the reception unit 552 outputs the driving signal SC to the first transistor 512 (as the first switch signal SW1 shown in FIG. 4) for conducting the first transistor 512. Meanwhile, the reception unit 552 also outputs the driving signal SC to the first delay unit 554. In such a situation, as shown in FIG. 5B, the first transistor 512 is turned on, and the second transistor 514 and the third transistor 516 are in cut-off state during the first period C1. Therefore, in the first period C1, the input voltage source Vin, the inductor 510 and the first transistor 512 form a first charging path IL1, and the input voltage source Vin charges the inductor 510.

On the other hand, after the first delay unit 554 receives the driving signal SC from the reception unit 552, the first delay unit 554 delays the driving signal SC. For example, the first delay unit 554 may delay the driving signal SC for a first delay time T1, wherein the first delay time T1 may equal to the length of the first period C1. After delaying the driving signal SC, the first delay unit 554 outputs the driving signal SC to the second transistor 514 and the second delay unit 556 at the beginning of the second period C2. That is, in the first period C1, the first transistor 512 is conducted, such that the input voltage source Vin charges the inductor 510. Meanwhile, in the first period C1, the first delay unit 554 delays the driving signal SC.

Further, at the beginning of the second period C2, the first delay unit 554 outputs the driving signal SC to the second transistor 514 (as the second switch signal SW2 shown in FIG. 4) for conducting the second transistor 514, and the first delay unit 554 also outputs the driving signal SC to the second delay unit 556. In such a situation, as shown in FIG. 5C, the second transistor 514 is turned on, and the first transistor 512 and the third transistor 516 are in cut-off state during the second period C2. Therefore, in the second period C2, the input voltage source Vin, the inductor 510 and the second transistor 514 form a second charging path IL2, and the input voltage source Vin charges the inductor 510.

After the second delay unit 556 receives the driving signal SC from the first delay unit 554, the second delay unit 556 delays the driving signal SC. For example, the second delay unit 556 may delay the driving signal SC for a second delay time T2, wherein the second delay time T2 may equal to the length of the second period C2. After delaying the driving signal SC, the second delay unit 556 outputs the driving signal SC to the third transistor 516 (as the third switch signal SW3 shown in FIG. 4) for conducting the third transistor 516 at the beginning of the third period C3. In such a situation, as shown in FIG. 5D, the third transistor 516 is turned on, and the first transistor 512 and the second transistor 514 are in cut-off state during the third period C3. Therefore, in the third period C3, the input voltage source Vin, the inductor 510 and the third transistor 516 form a third charging path IL3, and the input voltage source Vin charges the inductor 510. Therefore, the voltage boost circuit 50 sequentially conducts the transistors 512, 514, 516 in different periods for charging and storing energy in the inductor 510. In Brief, after the driving device outputs a driving signal SC, the transistors 512, 514, 516 of the voltage boost circuit 50 are sequentially conducted for performing energy storage process. As such, the frequency of total switch units of the voltage boost circuit 50 equals to three times the working frequency of single switch transistor, and the frequency of total switch units of the voltage boost circuit 50 equals to three times the output working frequency of the driving device, and thus increasing efficiency of the voltage boost circuit.

On the other hand, when the voltage boost circuit 50 is in a discharging process, the transistors 512, 514, 516 are turned off, and the inductor 510, the diode 520 and the output unit 540 form a discharge path, such that the inductor 510 transfers the stored energy to the output capacitor 542 for generating the output voltage Vout, so as to achieve the purpose of voltage conversion.

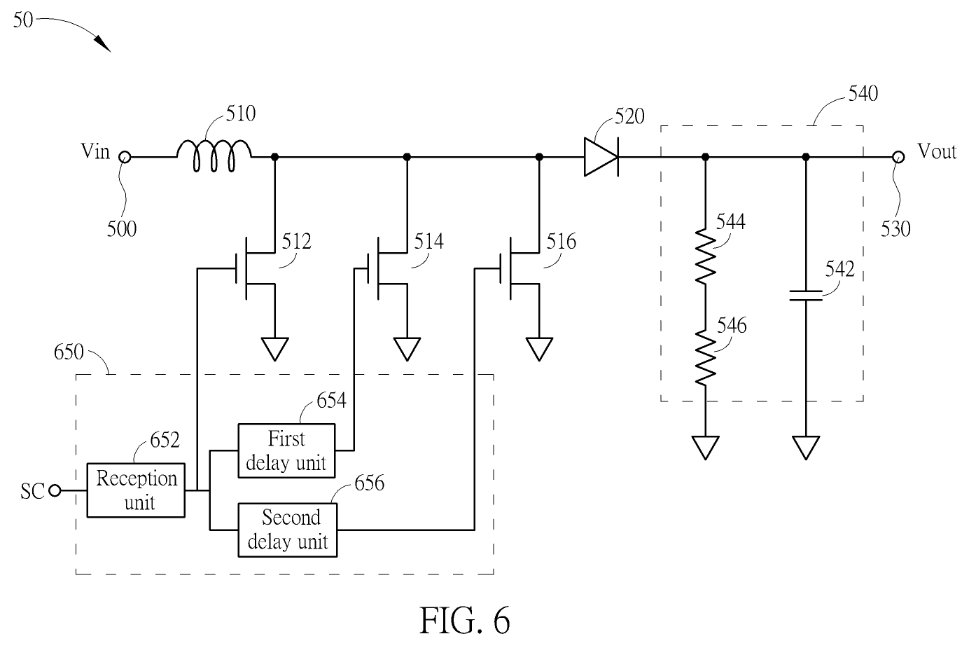

Please refer to FIG. 6, which is a schematic diagram illustrating a voltage boost circuit 60 according to an embodiment of the present invention. The voltage boost circuit 60 includes an input end 600, an inductor 610, a diode 620, an output end 630, an output unit 640, a control unit 650 and transistors 612, 614, 616. The output unit 640 includes an output capacitor 642 and output resistors 644, 646. The control unit 650 includes a reception unit 652, a first delay unit 654 and a second delay unit 656. Different from the voltage boost circuit 50 shown in FIG. 5A, the first delay unit 654 and the second delay unit 656 of the control unit 650 shown in FIG. 6 are coupled to the reception unit 652 in parallel. In detail, as shown in FIG. 6, after receiving the driving signal SC, the reception unit 652 of the control unit 650 transmits the driving signal SC to the transistor 612, the first delay unit 654 and the second delay unit 656 respectively. At the beginning of the first period C1, the reception unit 652 outputs the driving signal SC to the first transistor 612 (as the first switch signal SW1 shown in FIG. 4) for conducting the first transistor 612. In the first period C1, the first transistor 612 is conducted, the second transistor 614 and the third transistor 616 are in cut-off state. Therefore, in the first period C1, the input voltage source Vin, the inductor 610 and the first transistor 612 form a first charging path IL1, and the input voltage source Vin charges the inductor 610.

On the other hand, after the first delay unit 654 receives the driving signal SC from the reception unit 652, the first delay unit 654 delays the driving signal SC. At the beginning of the second period C2, the first delay unit 654 outputs the driving signal SC to the second transistor 614 (as the second switch signal SW2 shown in FIG. 4) for conducting the second transistor 614. In the second period C2, the second transistor 614 is conducted, such that the input voltage source Vin charges the inductor 510. After receiving the driving signal SC from the reception unit 652, the second delay unit 656 delays the driving signal SC. At the beginning of the third period C3, the second delay unit 656 outputs the driving signal SC to the third transistor 616 (as the third switch signal SW3 shown in FIG. 4) for conducting the third transistor 616. Therefore, in the third period C3, the third transistor 616 is conducted, such that the input voltage source Vin charges the inductor 510. Therefore, the voltage boost circuit 60 can conduct the transistors 612, 614, 616 respectively by delaying the driving signal so as to reduce the switching loss of the transistors 612, 614, 616. Moreover, the voltage boost circuit can avoid large current flowing through the transistors by parallelly connected transistors 612, 614, 616 so as to prevent overheating and damage to the transistors.

It is noted that the voltage boost circuit 30, 50, 60 are exemplary embodiments of the present invention, and those skilled in the art can make alternations and modifications accordingly. For example, the energy storage component may be a capacitor, an inductor or any other device which can store electrical energy. The switch units may be transistors such as metal oxide semiconductor field effect transistors, insulated gate bipolar transistors or bipolar junction transistors, but not limited thereto.

In summary, the conventional voltage boost circuit often causes the large current flows through single transistor and single transistor overheats and is destroyed. In comparison, the embodiments of the present invention can keep the transistor from overheat or being damaged. More importantly, the embodiments of the present invention can reduce the switching frequency of the single transistor to improve the efficiency of the voltage boost circuit by delaying arrangement of the driving signal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A voltage boost circuit comprising:
an energy storage component coupled to an input voltage source;
a plurality of switch units, wherein when each of the switch units is conducted, the input voltage source, the energy storage component and the each switch unit form a conducting path, such that the input voltage source charges the energy storage component; and
a control unit for sequentially conducting the plurality of switch units according to a driving signal.

2. The voltage boost circuit of claim 1, wherein the control unit outputs the driving signal to a first switch unit of the plurality of switch units to conduct the first switch unit in a first period, such that the input voltage source, the energy storage component and the first switch unit form the conducting path and the input voltage source charges the energy storage component, and the control unit outputs the driving signal to a second switch unit of the plurality of switch units to conduct the second switch unit in a second period, such that the input voltage source, the energy storage component and the second switch unit form the conducting path and the input voltage source charges the energy storage component.

3. The voltage boost circuit of claim 2, wherein the first period and the second period are not overlapping.

4. The voltage boost circuit of claim 2, wherein the control unit comprises:
a reception unit for receiving the driving signal and providing the driving signal to the first switch unit for conducting the first switch unit in the first period; and
a first delay unit for receiving the driving signal from the reception unit and delaying the driving signal, so as to provide the driving signal to the second switch unit for conducting the second switch unit in the second period posterior to the first period.

5. The voltage boost circuit of claim 4, wherein the control unit further comprises:
a second delay unit for receiving the driving signal from the reception unit or the first delay unit and delaying the driving signal, so as to provide the driving signal to a third switch unit of the plurality of switch units for conducting the third switch unit in a third period posterior to the second period, such that the input voltage source, the energy storage component and the third switch unit form the conducting path and the input voltage source charges the energy storage component in the third period.

6. The voltage boost circuit of claim 1, further comprising:
a diode coupled to the energy storage component; and
an output unit for outputting an output voltage comprising:
an output capacitor coupled to the diode;
wherein when the plurality of the switch units are off, the energy storage component, the diode and the output capacitor form a discharge path, such that the energy storage component transfers the stored energy to the output capacitor to generate the output voltage.

7. The voltage boost circuit of claim 1, further comprising:
a first resistor comprising a first end coupled to the diode, and a second end; and
a second resistor comprising a first end coupled to the second end of the first resistor, and a second end coupled to a ground end.

8. The voltage boost circuit of claim 1, wherein the energy storage component is a capacitor or an inductor.

9. The voltage boost circuit of claim 1, wherein the plurality of the switch units are metal oxide semiconductor field effect transistors, insulated gate bipolar transistors or bipolar junction transistors.
